(19) United States
(12) Patent Application Publication
(10) Pub. No.: US 2008/0103893 A1
(43) Pub. Date: May 1, 2008

(54) System and method for generating forecasted bids for advertisement keywords

(75) Inventors: Anantharaman Nagarajan, San Jose, CA (US); Chi-Chao Chang, Santa Clara, CA (US); Pratyush Seth, San Jose, CA (US)

Correspondence Address: YAHOO! INC.;C/O DREIER LLP, 499 PARK AVENUE, NEW YORK, NY, 10022, US

(73) Assignee: Yahoo! Inc., Sunnyvale, CA (US)

(21) Appl. No.: 11/590,044

(22) Filed: Oct. 30, 2006

(51) Int. Cl. G06Q 30/00

(52) U.S. Cl. 705/14

(57) ABSTRACT

The present invention is directed towards systems and methods for generating a forecasted bid amount for a keyword in order to display one or more advertisements in response to a search request that includes the keyword at a given position within a ranked list of advertisements. The method may comprise receiving an advertiser request specifying a keyword, an advertisement group, and a position within a ranked list of advertisements, identifying one or more advertisements displayed in response to the keyword at the advertiser specified position and retrieving a bid amount and a quality score associated with the one or more identified advertisements with respect to the advertiser specified keyword. A quality score is calculated for the advertiser specified advertisement group with respect to the advertiser specified keyword and a forecasted bid amount is calculated through use of the quality score associated with the advertiser specified advertisement group and the one or more bid amounts and quality scores associated with the one or more identified advertisements.

### CROSS-REFERENCE TO RELATED APPLICATIONS

The present application is related to the following commonly owned U.S. patent applications:

U.S. patent application Ser. No. 11/324,129, entitled “SYSTEM AND METHOD FOR ADVERTISEMENT MANAGEMENT,” file on Dec. 30, 2005 and assigned attorney docket number 7345/09;

U.S. patent application Ser. No. 11/414,516, entitled “SYSTEM AND METHOD FOR FORECASTING THE PERFORMANCE OF ADVERTISEMENTS,” filed on Apr. 28, 2006 and assigned attorney docket number 7345/29; and

U.S. patent application Ser. No. 11/479,186, entitled “SYSTEM AND METHOD FOR GENERATING FUNCTIONS TO PREDICT THE CLICKABILITY OF ADVERTISEMENTS,” filed on Jun. 29, 2006 and assigned attorney docket number 7345/30;

The disclosures of which are hereby incorporated by reference herein in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention is directed toward providing methods and systems for generating bids for advertisement keywords. More specifically, the present invention is directed towards generating a real time forecast of a bid amount for a keyword in order to display one or more advertisements associated with the keyword at an advertiser specified position in a ranked list of one or more advertisements.

### BACKGROUND OF THE INVENTION

Advertisements are commonly used on the Internet to promote various products and services. Advertisements may comprise banner ads, links to web pages, images, video, text, etc. Advertisements used to promote products on the Internet are commonly displayed in a ranked result set in response to a query. The advertisements displayed to a user of a client device may be selected, redirecting a user to a website providing the product or service advertised.

Client devices, communicatively coupled to a network, such as the Internet, are capable of accessing various websites that may display advertisements. For example, a user of a client device may submit a search query comprising one or more terms to a search engine, which causes the search engine to retrieve a result set comprising links to content, as well as advertisements responsive to the search terms provided by a user. The search engine may display the result set that it generates to a user who may then select or view items in the result set, including one or more advertisements.

The Internet provides advertisers with the ability to reach a significant quantity of users, thereby increasing the likelihood that a given product or service is purchased by a user. Advertisers, however, must pay for the advertisements that a search engines displays in response to various requests. For example, in a bidding market place advertisers may bid upon keywords associated with one or more advertisements. Queries received by a search engine comprising one or more keywords may be used to select advertisements based upon advertiser bid amounts for the one or more respective keywords.

Therefore, while Internet advertising may allow an advertiser to increase the likelihood that products or services are purchased, Internet advertising also involves expending resources. Because advertisers are expending resources on advertisements, the performance of advertisements is a significant concern. The performance of advertisements may be based upon the frequency with which advertisements are displayed in response to a given search query. Similarly, the performance of advertisements may be based upon the frequency with which users select advertisements.

In a bidding marketplace, the performance of advertisements may be closely related to the keywords associated with the advertisements. For example, an advertisement with the greatest associated bid for a given keyword may be displayed first in a ranked list of advertisements in response to a search comprising the keyword. An advertisement ranked and displayed first in a result set is more likely to be selected by a given user than an advertisement ranked seventh, eight, ninth, etc.

Advertisers may wish to ascertain such performance information prior to bidding upon one or more keywords associated with one or more advertisements. For example, advertisers may wish to ascertain the position at which a given advertisement is displayed in response to a given keyword at a given bid amount. While current techniques may provide an advertiser with information identifying the performance of advertisements, existing techniques are limited to providing such information only after an advertiser's one or more advertisements are distributed.

Existing techniques thus fail to provide information indicating the projected or forecasted performance of one or more advertisements associated with one or more keywords or information identity a bid amount necessary to display an advertisement in response to a given keyword at a given position. In order to overcome shortcomings associated with existing techniques, the present invention provides systems and methods for forecasting the bid amount necessary for a given keyword in order to display one or more advertisements associated with the keyword at a given advertiser specified position in a ranked list of one or more advertisements.

### SUMMARY OF THE INVENTION

The present invention is directed to systems and methods for forecasting a bid for an advertisement, which may comprise a bid to display an advertisement at a given position in a list of advertisements ranked in accordance with one or more bids. One embodiment of the present invention is directed towards a method for generating a forecasted bid amount for a keyword in order to display one or more advertisements in response to a search request that includes the keyword at a given position within a ranked list of advertisements. The method according to the present embodiment comprises receiving an advertiser request specifying a keyword, an advertisement group, and a position within a ranked list of advertisements. An advertisement group may comprise one or more advertisements and a position comprises a numerical ranking within a ranked list of one or more advertisements. A position may also comprise a location within a search results page comprised of one or more locations for displaying one or more advertisements.

The method continues with identifying one or more advertisements displayed in response to the keyword at the advertiser specified position and retrieving a bid amount and a quality score associated with the one or more identified advertisements with respect to the advertiser specified keyword. A quality score is calculated for the advertiser specified advertisement group with respect to the advertiser specified keyword. A forecasted bid amount is calculated through use of the quality score associated with the advertiser specified advertisement group and the one or more bid amounts and quality scores associated with the one or more identified advertisements. The forecasted bid amount is calculated through the use of the quality score, which may comprise a numerical indication of a relative quality of an advertisement with respect to a given keyword. A numerical indication of a relative quality of an advertisement with respect to a given keyword may comprise a numerical indication of an extent to which a given advertisement matches or is similar to a given keyword.

According to one embodiment, calculating a quality score for the advertiser specified advertisement group with respect to the advertiser specified keyword comprises calculating a quality score for the one or more advertisements comprising the advertiser specified advertisement group with respect to the advertiser specified keyword and calculating the average quality score through use of the quality scores associated with the one or more advertisements. According to another embodiment, calculating a quality score for the advertiser specified advertisement group with respect to the advertiser specified keyword comprises calculating a quality score for the one or more advertisements comprising the advertiser specified advertisement group with respect to the advertiser specified keyword and selecting a greatest quality score from among the one or more quality scores associated with the one or more advertisements. According to a third embodiment, calculating a quality score for the advertiser specified advertisement group with respect to the advertiser specified keyword comprises calculating a quality score for the one or more advertisements comprising the advertiser specified advertisement group with respect to the advertiser specified keyword and selecting a lowest quality score from among the one or more quality scores associated with the one or more advertisements.

Calculating a forecasted bid amount through use of the quality score associated with the advertiser specified advertisement group and the one or more bid amounts and quality scores associated with the one or more identified advertisements may comprise calculating a quotient of a product of the quality score and the bid amount associated with the one or more advertisements displayed in response to the advertiser specified keyword at the advertiser specified position, and the quality score associated with the advertiser specified advertisement group and calculating the average of the calculated quotients. According to another embodiment calculating a forecasted bid amount through use of the quality score associated with the advertiser specified advertisement group and the one or more bid amounts and quality scores associated with the one or more identified advertisements comprises calculating a quotient of a product of the quality score and the bid amount associated with the one or more advertisements displayed in response to the advertiser specified keyword at the advertiser specified position, and the quality score associated with the advertiser specified advertisement group and selecting the greatest quotient.

Calculating a forecasted bid amount through use of the quality score associated with the advertiser specified advertisement group and the one or more bid amounts and quality scores associated with the one or more identified advertisements may also comprise calculating a quotient of a product of the quality score and the bid amount associated with the one or more advertisements displayed in response to the advertiser specified keyword at the advertiser specified position, and the quality score associated with the advertiser specified advertisement group and selecting the lowest quotient.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for generating a real time forecast of a bid amount necessary for a given keyword in order to display one or more advertisements associated with the keyword at a given position in a ranked list of one or more advertisements according to one embodiment of the present invention;

FIG. 2 is a flow diagram illustrating one embodiment of a method for generating a real time forecast of a bid amount necessary for a given keyword in order to display one or more advertisements associated with the keyword at an advertiser specified position in a ranked list of advertisements according to one embodiment of the present invention; and

FIG. 3 is a flow diagram illustrating one embodiment of a method for calculating a bid amount for a given keyword in order to display one or more advertisements associated with the keyword at a given position in a ranked list of one or more advertisements.

### DETAILED DESCRIPTION OF THE PREFERRED EMBODIMENT

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

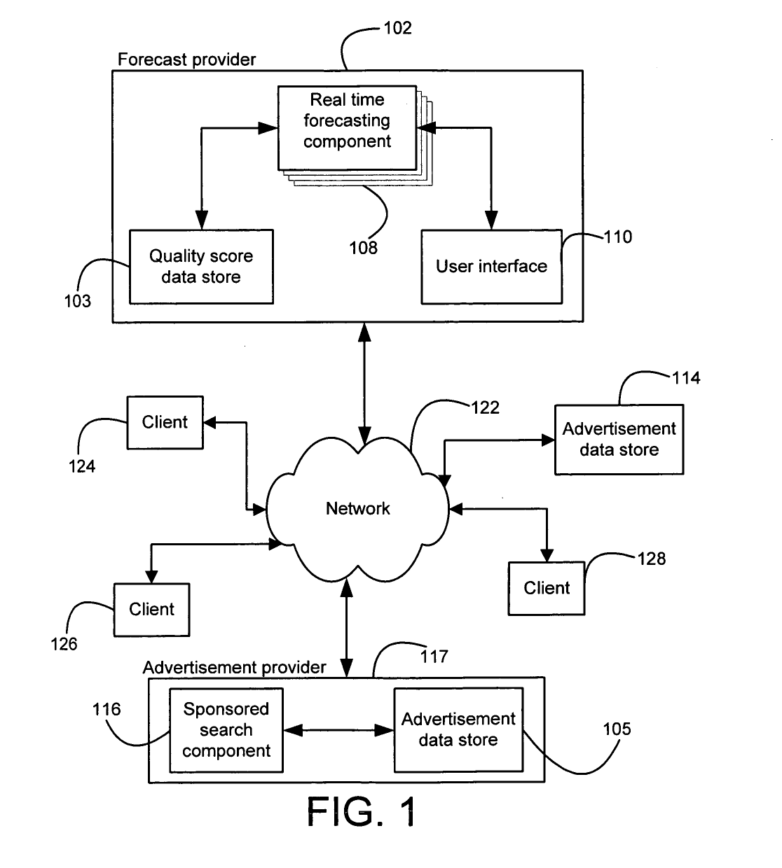

FIG. 1 presents a block diagram depicting one embodiment of a system for forecasting a bid amount for a given keyword in order to display one or more advertisements associated with the keyword at an advertiser specified position in a ranked list of one or more advertisements. According to the embodiment illustrated in FIG. 1, client devices 124, 126 and 128 are communicatively coupled to a network 122, which may include a connection to various combinations of one or more local and wide area networks, such as the Internet. According to one embodiment of the invention, a client device 124, 126 and 128 is a general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A user of a client device 124, 126, and 128 communicatively coupled to the network 122 may transmit a search query comprising one or more terms to an advertisement provider 117. A typical query received from a user of a client device 124, 126, and 128 has one or more terms. For example, the query “wireless notebook computer” contains three terms and may be referred to as a three-term query. Similarly, queries containing only one term are referred to as one-term queries, queries containing two terms are two-term queries, etc. A space or other delimiter character may be used to identify the individual terms comprising a given query.

Queries received by the advertisement provider 117 are delivered to a sponsored search component 116 operative to identify one or more advertisements responsive to a given received query. The sponsored search component 116 may examine one or more local or remote advertisement data stores 105 and 114, respectively, to identify one or more advertisements responsive to a given received query. Local 105 and remote 114 advertisement data stores are operative to maintain one or more advertisements and may comprise one or more accessible memory structures such as a database, CD-ROM, tape, digital storage library, etc. Local and remote advertisement data stores 105 and 114 may be implemented as databases or any other type of storage structures capable of providing for the retrieval and storage of a variety of data types. The advertisement data stores 105 and 114 may store a variety of advertisement data types including websites, text, video, images, banners, links, etc. Advertisements maintained in advertisement data stores 105 and 114 may be maintained in groups according to advertiser, product, category, or a combination thereof

According to one embodiment of the invention, advertisements maintained in advertisement data stores 105 and 114 are maintained according to one or more advertisement groups, wherein a given an advertisement group comprises one or more advertisements associated with a given advertiser and directed toward a common advertising goal. For example, a given advertisement group may comprise one or more advertisements associated with a given advertiser that are directed toward selling convertible vehicles. Similarly, a given advertisement group may comprise one or more advertisements associated with a given advertiser that are directed toward selling laptop computers.

The one or more advertisement groups maintained in the advertisement data stores 105 and 114 are associated with one or more advertiser specified keywords. The one or more keywords associated with a given advertisement group may be used to select one or more advertisements for distribution in response to a given search request received from a client device 124, 126, and 128. For example, a given advertisement group may be directed toward selling wireless routers. Accordingly, the advertiser may specify that the advertisement group is associated with the keywords “wireless,” “wireless router,” “802.11,” etc. When a search query is received from a given user's client device 124, 126, and 128 the sponsored search component 116 at the advertisement provider 117 may search the advertisement data stores 105 and 114 to determine whether the one or more terms comprising the search query have been specified by an advertiser as associated with one or more advertisement groups.

The one or more keywords associated with a given advertisement, as specified by an advertiser, are further associated with one or more advertiser specified bid amounts. An advertiser's bid amount provides an indication of the dollar amount the advertiser is willing to bid on the one or more keywords associated with the one or more advertisements, which may be related in accordance with a given advertisement. An advertiser may provide a bid for the one or more keywords associated with a given advertisement. For example, a given advertiser may specify that the keywords “notebook computer” and “laptop computer” are associated with the advertiser's advertisement directed toward advertising notebook computers. The advertiser may further provide a bid amount for the keywords “notebook computer” and “laptop computer.” The bid amounts provide an indication of the dollar value the advertiser is willing to spend to display a given advertisement (or advertisements in an advertisement group) in response to a search query comprising the one or more advertiser specified keywords.

The sponsored search component 116 may utilize the bid amounts for the one or more keywords associated with the one or more advertisements in a given advertisement group to select and rank one or more advertisements in response to a request. For example, the sponsored search component 116 may receive a search request from a client device 124, 126, and 128 communicatively coupled to the network 122 comprising a search query of one or more terms. The sponsored search component 116 may search advertisement data stores 105 and 114 to determine whether one or more advertisers have provided bids for keywords that match or are similar to the one or more terms comprising the search query. The sponsored search component 116 may identify the one or more advertisers that provided bids for the one or more keywords that match or are similar to the one or more terms comprising the search query and select one or more advertisements from the one or more advertisers' advertisement groups that have provided bids for such keywords. The bids associated with the one or more advertisements may be used to rank the one or more identified advertisements. For example, an advertisement associated with an advertiser that provided a greatest bid amount for a given keyword may be placed first in a ranked list of advertisements.

The sponsored search component 116 may further utilize a quality score to determine a ranking or positioning for one or more advertisements associated with a given keyword. A quality score may comprise a numerical indication of advertisement performance quality that is based upon one or more performance parameters to quantify the relative quality of an advertisement, e.g., clickability. According to one embodiment of the invention, a quality score comprises a numerical indication of the relative quality of an advertisement with respect to one or more keywords. For example, a quality score may comprise an indication of the extent to which a given advertisement matches or is similar to a given keyword., and may further indicate a likelihood that a given advertisement is to be selected when presented in response to a given query comprising a keyword associated with the given advertisement.

The sponsored search component 116 may generate a search results page comprising the one or more advertisements selected in response to the request received from a client device 124, 126, and 128. As previously described, the positioning or ranking of a given advertisement within the search results page may be based upon the bid and the quality score associated with the given advertisement. For example, an advertisement with a greatest bid and quality score may be placed first in a ranked list of advertisements. Similarly, an advertisement with a greatest bid and quality score may be positioned in the most prominent position of a search results page.

Information associated with the one or more advertisements distributed in response to a query comprising a given keyword may be delivered to a quality score data store 103 at a forecast provider 102. According to one embodiment of the invention, the information delivered to the quality score data store 103 for one or more advertisements comprises the keyword that resulted in the display of a given advertisement, the bid associated with respective keyword, and the position at which the advertisement was displayed in response to the keyword. For example, a search request comprising the keyword “vacations” may be received from a given user of a client device 124, 126, 128. The one or more advertisements responsive to the keyword “vacations” may be identified, and a search results page may be generated comprising the one or more responsive advertisements, ordered according to the bid and quality score associated with the one or more advertisements. The bids associated with the one or more advertisements with respect to the keyword “vacations,” as well as the position at which the one or more advertisements were displayed in response to the keyword “vacations” may be delivered to the quality score data store 103.

The quality score data store 103 may be operative to aggregate data received for one or more keywords and advertisements with existing data maintained in the quality score data store 103. For example, the sponsored search component 116 at the advertisement provider 117 may generate a search results page comprising one or more advertisements responsive to a search request comprising the keyword “computers.” Information associated with the one or more advertisements comprising the search results page, including the quality score, bid, and position at which the one or more advertisements area displayed within the search results page, may be delivered to the quality score data store 103 at the forecast provider 102.

Continuing with the prior example, the quality score data store 103 according to one embodiment is operative to determine whether any data has been received for the one or more advertisements displayed within the search results page in response to the keyword “computers.” If existing data is found for any of the one or more advertisements, the quality score data store 103 may aggregate the existing data with the data received from the sponsored search component 116. Alternatively, the quality score data store 103 may replace the existing data for the one or more advertisements with respect to the keyword “computers” with the data received from the sponsored search component 116. Aggregating existing data with data received from the sponsored search component 116, or replacing existing data with data received from the sponsored search component 116, ensures that the quality score data store 103 maintains the most recent information for one or more advertisements with respect to a given keyword.

A real time forecasting component 108, which may comprise one or more servers or modules (which may operate in parallel), is operative to retrieve the data maintained in the quality score data store 103 in order to generate a real time forecast of a bid amount necessary to display one or more advertisements at a given position in response to a given keyword. According to one embodiment of the invention, one or more advertisers may access the real time forecasting component 108 via a user interface 110 at the forecast provider 102. The user interface 110 may comprise a load balancer, operative to deliver requests from one or more advertisers to the one or more servers or modules comprising the real time forecasting component 108.

A given advertiser accessing the real time forecasting component 108 via the user interface 110 may generate a request for a bid amount necessary for a given keyword in order to display one or more advertisements from a given advertisement group associated with the advertiser in response to the keyword at a given position. For example, an advertiser may deliver a request to the real time forecasting component 108 via the user interface 110 requesting the bid amount necessary to display one or more advertisements from a given advertisement group associated with the advertiser in response to the keyword “computer” at a first position in a ranked list of advertisements.

The real time forecasting component 108 is operative to search the quality score data store 103 and retrieve information associated with the one or more advertisements displayed in response to the advertiser specified keyword at the advertiser specified position. For example, with reference to the abovementioned example, the forecasting component 108 may search the quality score data store 103 and retrieve data associated the one or more advertisements displayed in response to the keyword “computer” at a first position in a ranked list of advertisements. According to one embodiment of the invention, the data retrieved by the real time forecasting component 108 comprises the bid provided by an advertiser associated with the advertisement displayed in response to the keyword, as well as the quality score of the advertisement displayed.

The real time forecasting component 108 is further operative to generate a quality score for the advertiser specified advertisement or advertisement group. For example, as previously described, an advertiser may deliver a request to the real time forecasting component 108 for the bid amount to display one or more advertisements from a given advertisement group at a given position in response to a given keyword. The real time forecasting component 108 may calculate a quality score for the advertiser specified advertisement or advertisement group. According to one embodiment of the invention, the quality score of an advertisement group comprises the average quality score of the one or more advertisements in the advertisement group. According to another embodiment of the invention, the quality score of an advertisement group comprises the lowest quality score of the one or more advertisements in the advertisement group. According to a further embodiment of the invention, the quality score of an advertisement group comprises the greatest quality score of the one or more advertisements in the advertisement group. Those of skill in the art recognize a number of techniques that may be used to generate a quality score for an advertisement group.

The real time forecast component 108 is operative to utilize the quality score associated with the advertiser specified advertisement or advertisement group, as well as the information associated with the one or more advertisements displayed in response to the advertiser specified keyword, to generate a real time bid forecast for the advertiser specified position. The forecast generated by the real time forecast component 108 may be delivered to the advertiser via the user interface 110. The advertiser from which the request originated may utilize the bid forecast generated by the real time forecast component 108 to bid upon the keyword.

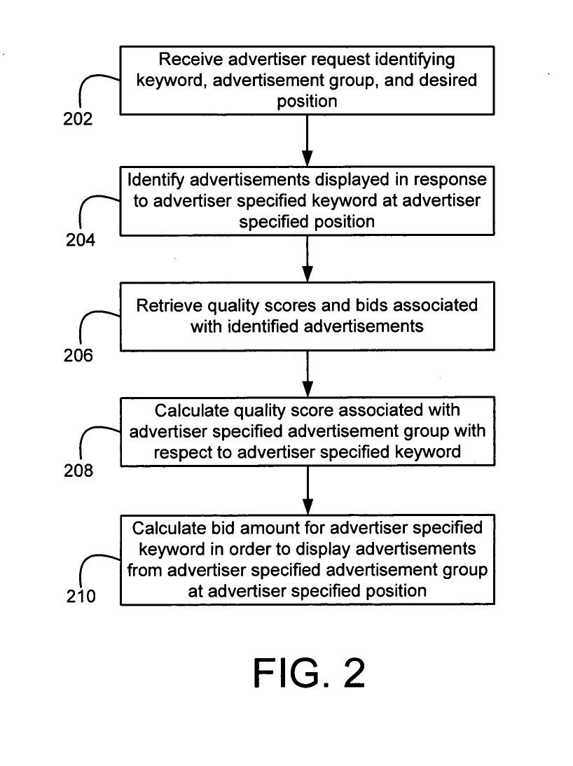

FIG. 2 illustrates one embodiment of a method for generating a forecast of a bid amount necessary for a given keyword in order to display one or more advertisements associated with the keyword at an advertiser specified position in a ranked list of advertisements. As illustrated in FIG. 2, a request is received from a given advertiser for a bid forecast, step 202. According to one embodiment of the invention, an advertiser request comprises a keyword, an advertisement group, and a position at which the advertiser wishes to display one or more advertisements from the advertiser specified advertisement group in response to a search request including the advertiser specified keyword.

The one or more advertisements displayed in response to the advertiser specified keyword at the advertiser specified position are identified, step 204. For example, an advertiser request may comprise the keyword “computer,” “Ad Group 1,” and the position “North,” indicating that the advertiser wishes to obtain a bid amount necessary to display one or more advertisements from the advertisement group “Ad Group 1” in the “North” position of a search results page in response to the keyword “computer.” The one or more advertisements displayed in response to the keyword “computer” in the “North” position of a search results page may be identified.

The quality scores and the bids associated with the identified advertisements (with respect to the advertiser specified keyword) are thereafter retrieved, step 206. As previously described, the quality score associated with a given advertisement may identify the relative quality of the advertisement with respect to a given keyword. The bid associated with a given keyword identifies the amount of money an advertiser is willing to pay in order to display one or more advertisements in response to the keyword.

The quality score of the advertiser specified advertisement group with respect to the advertiser specified keyword is thereafter calculated, step 208. According to one embodiment of the invention, the quality score of a given advertisement group with respect to a given keyword comprises the average quality score of the one or more advertisements in the advertisement group with respect to the keyword. According to another embodiment of the invention, the quality score of a given advertisement group with respect to a given keyword comprises the greatest quality score among the one or more quality scores associated with the one or more advertisements in the advertisement group with respect to the keyword. According to a further embodiment of the invention, the quality score of a given advertisement group with respect to a given keyword comprises the lowest quality score among the one or more quality scores associated with the one or more advertisements in the advertisement group with respect to the keyword.

The quality score associated with the advertiser specified advertisement group with respect to the advertiser specified keyword, as well as the bids and quality scores associated with the one or more advertisements displayed in response to the advertiser specified keyword are used to calculate a forecasted bid amount, step 210. The forecasted bid amount provides a forecast of the bid amount necessary in order to display a given advertisement from the advertiser specified advertisement group in response to the advertiser specified keyword at the advertiser specified position.

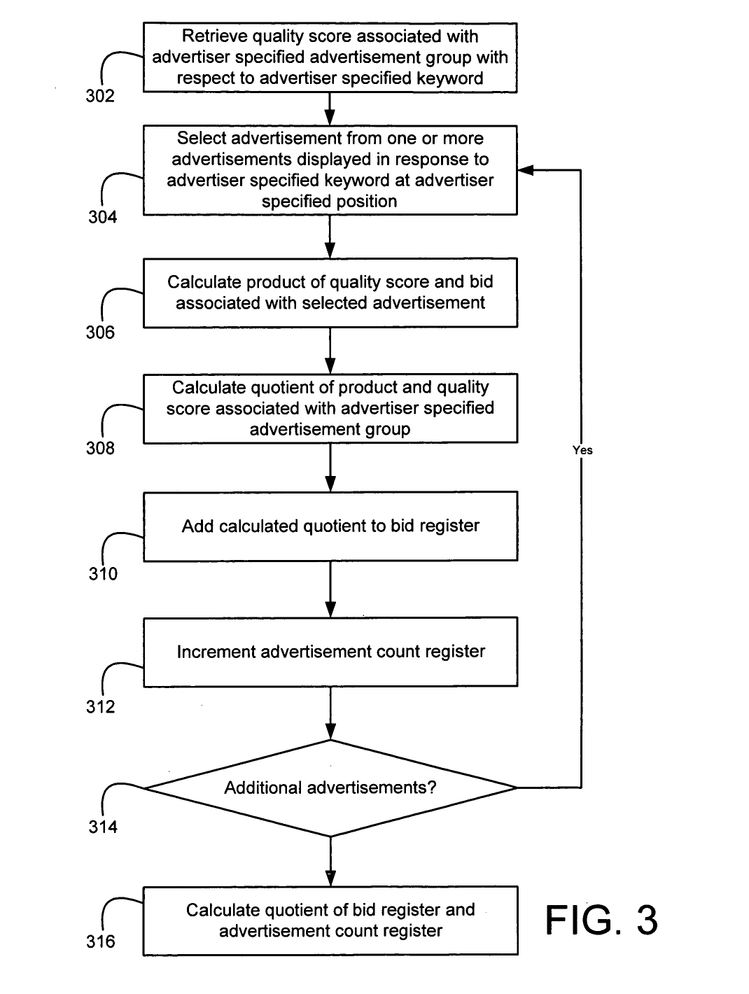

FIG. 3 illustrates one embodiment of a method for calculating a forecasted bid amount for an advertiser specified keyword through use of the quality score associated and with an advertiser specified advertisement group with respect to an advertiser specified keyword; the one or more bids and quality scores associated with the one or more advertisements displayed in response to the advertiser specified keyword.

The quality score associated with the advertiser specified advertisement group with respect to the advertiser specified keyword, calculated according to methods described herein, is retrieved, step 302. An advertisement is selected from among the one or more advertisements displayed in response to the advertiser specified keyword at the advertiser specified position, step 304. As previously described, a given advertisement displayed in response to a given keyword is associated with a quality score and a bid. The product of the quality score and the bid associated with the selected advertisement is calculated, step 306. The quotient of the calculated product and the quality score associated with the advertiser specified advertisement group with respect to the advertiser specified keyword is thereafter calculated, step 308.

The calculated quotient is added to a bid register, step 310. According to one embodiment of the invention, a bid register comprises a memory device for storing a given numeric value. An advertisement count register is thereafter incremented in order to identify the number of advertisements that have been analyzed, step 312. A check is performed to determine whether one or more additional advertisements displayed in response to the advertiser specified keyword at the advertiser specified position require analysis, step 314. If one or more additional advertisements require analysis, a next advertisement is selected. When the one or more advertisements displayed in response to the advertiser specified keyword at the advertiser specified position have been analyzed, the quotient of the bid register and the advertisement count register is calculated, step 316. The calculated quotient yields the average forecasted bid amount necessary to display one or more advertisements from the advertiser specified advertisement group in response to the advertiser specified keyword at the advertiser specified position in a ranked list of one or more advertisements.

Table A illustrates one embodiment of an equation that may be used to generated a forecasted bid amount for a given keyword through use of the quality score and bid amount associated with one or more advertisements displayed in response to the keyword at a given position, as well as the quality score associated with an advertiser specified advertisement group.

TABLE A
$Forecasted Bid = \frac{( QS ) * Bid}{{QS}^{′}}$

In the equation presented in Table A, “QS” comprises the quality score for a given advertisement displayed in response to an advertiser specified keyword at an advertiser specified position. “Bid” comprises the bid amount associated with the advertisement displayed in response to the advertiser specified keyword at the advertiser specified position. “QS′” comprises the quality score associated with an advertiser specified advertisement group. “Forecasted Bid” comprises the forecasted bid amount necessary in order to display an advertisement from the advertiser specified advertisement group in response to a search request including the advertiser specified keyword at the advertiser specified position within a ranked list of advertisements. As previously described, the average, greatest, or least Forecasted Bid amount calculated for the one or more advertisements displayed in response to a given advertiser specified keyword at an advertiser specified position may be used to identify a forecast of a bid amount necessary to display one or more advertisements in response to an advertiser specified keyword at a given advertiser specified position.

Those of skill in the art recognize that while the embodiment illustrated in FIG. 3 provides for the calculation of an average bid amount necessary to display one or more advertisements in response to a given keyword, the embodiment illustrated in FIG. 3 may be modified so as to generate a greatest or least bid amount in order to display an advertisement in response to a given keyword. For example, the embodiment illustrated in FIG. 3 may be modified so as to identify the lowest bid amount that will result in an advertisement from an advertiser specified advertisement group being displayed in response to an advertiser specified keyword at an advertiser specified position. Similarly, the embodiment illustrated in FIG. 3 may be modified so as to identify the greatest bid amount that will result in an advertisement from an advertiser specified advertisement group being displayed in response to an advertiser specified keyword at an advertiser specified position.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for generating a forecasted bid amount for a keyword in order to display one or more advertisements in response to a search request that includes the keyword at a given position within a ranked list of advertisements, the method comprising:
receiving an advertiser request specifying a keyword, an advertisement group, and a position within a ranked list of advertisements;
identifying one or more advertisements displayed in response to the keyword at the advertiser specified position;
retrieving a bid amount and a quality score associated with the one or more identified advertisements with respect to the advertiser specified keyword;
calculating a quality score for the advertiser specified advertisement group with respect to the advertiser specified keyword; and
calculating a forecasted bid amount through use of the quality score associated with the advertiser specified advertisement group and the one or more bid amounts and quality scores associated with the one or more identified advertisements.

2. The method of claim 1 wherein an advertisement group comprises one or more advertisements.

3. The method of claim 1 wherein a position comprises a numerical ranking within a ranked list of one or more advertisements.

4. The method of claim 1 wherein a position comprises a location within a search results page comprised of one or more locations for displaying one or more advertisements.

5. The method of claim 1 wherein a quality score comprises a numerical indication of a relative quality of an advertisement with respect to a given keyword.

6. The method of claim 5 wherein a numerical indication of a relative quality of an advertisement with respect to a given keyword comprises a numerical indication of an extent to which a given advertisement matches or is similar to a given keyword.

7. The method of claim 1 wherein calculating a quality score for the advertiser specified advertisement group with respect to the advertiser specified keyword comprises:
calculating a quality score for the one or more advertisements comprising the advertiser specified advertisement group with respect to the advertiser specified keyword; and
calculating the average quality score through use of the quality scores associated with the one or more advertisements.

8. The method of claim 1 wherein calculating a quality score for the advertiser specified advertisement group with respect to the advertiser specified keyword comprises:
calculating a quality score for the one or more advertisements comprising the advertiser specified advertisement group with respect to the advertiser specified keyword; and
selecting a greatest quality score from among the one or more quality scores associated with the one or more advertisements.

9. The method of claim 1 wherein calculating a quality score for the advertiser specified advertisement group with respect to the advertiser specified keyword comprises:
calculating a quality score for the one or more advertisements comprising the advertiser specified advertisement group with respect to the advertiser specified keyword; and
selecting a lowest quality score from among the one or more quality scores associated with the one or more advertisements.

10. The method of claim 1 wherein calculating a forecasted bid amount through use of the quality score associated with the advertiser specified advertisement group and the one or more bid amounts and quality scores associated with the one or more identified advertisements comprises:
calculating a quotient of a product of the quality score and the bid amount associated with the one or more advertisements displayed in response to the advertiser specified keyword at the advertiser specified position, and the quality score associated with the advertiser specified advertisement group; and
calculating the average of the calculated quotients.

11. The method of claim 1 wherein calculating a forecasted bid amount through use of the quality score associated with the advertiser specified advertisement group and the one or more bid amounts and quality scores associated with the one or more identified advertisements comprises:
calculating a quotient of a product of the quality score and the bid amount associated with the one or more advertisements displayed in response to the advertiser specified keyword at the advertiser specified position, and the quality score associated with the advertiser specified advertisement group; and
selecting the greatest quotient.

12. The method of claim 1 wherein calculating a forecasted bid amount through use of the quality score associated with the advertiser specified advertisement group and the one or more bid amounts and quality scores associated with the one or more identified advertisements comprises:
calculating a quotient of a product of the quality score and the bid amount associated with the one or more advertisements displayed in response to the advertiser specified keyword at the advertiser specified position, and the quality score associated with the advertiser specified advertisement group; and
selecting the lowest quotient.
